(19) United States
(12) Patent Application Publication
(10) Pub. No.: US 2013/0253966 A1
(43) Pub. Date: Sep. 26, 2013

(54) SAVING TRACKER SYSTEM AND METHOD

(71) Applicants: BIKASH MOHANTY, MUMBAI (IN); PRASAD NAIR, MUMBAI (IN)

(72) Inventors: BIKASH MOHANTY, MUMBAI (IN); PRASAD NAIR, MUMBAI (IN)

(21) Appl. No.: 13/558,924

(22) Filed: Jul. 26, 2012

(30) Foreign Application Priority Data
Mar. 20, 2012 (IN) 732/MUM/2012

(51) Int. Cl. G06Q 10/00; G06Q 40/00

(52) U.S. Cl. 705/7.11

(57) ABSTRACT

System and method for analysis of cost saving in a procurement process are described. The system includes a processor unit and a computer readable medium. The computer readable medium stores instructions executable by the processor unit. The instructions are programmed to perform the steps of receiving baseline cost information, receiving purchase cost information, and computing a plurality of components of cost saving. The instructions are also programmed to transfer indication of the computed components of cost saving to display device and/or financial accounting system. Moreover, the instructions are programmed to adjust at least one of the plurality of the components of the cost saving utilizing at least one factor selected from the group consisting of currency exchange rate, commodity price, and inflation rate.

### CROSS-REFERENCE TO RELATED APPLICATION

The instant application claims priority to Indian Patent Application Ser. No. 732/MUM/2012, filed Mar. 20, 2012, pending, the entire specification of which is expressly incorporated herein by reference.

### FIELD OF INVENTION

The present invention is generally related to the function of procurement of goods and services in organizations.

### BACKGROUND OF THE INVENTION

In many organizations, the procurement department procures goods and services for the various business units or business functions within the organization. Merely as examples, goods and services procured can include physical items such as raw material, fuel, product components, etc. Also merely as examples, goods and services procured can include other items such as freight capacity, advertising time, Internet bandwidth, legal services, etc.

The procurement cost is often an important aspect of the overall operational efficiency and/or the financial bottom line of the organization. Accordingly, the procurement departments and/or professionals are often incentivized to reduce the procurement cost. The reduction in procurement cost is also called as “cost saving.” The saving attained is often indicative of performance of the procurement departments/professionals. The cost saving also impacts organization's financial accounts. It thus becomes desirable to provide techniques for detailed analysis of cost saving attained in the procurement process.

### SUMMARY OF THE INVENTION

It is an object of the present invention to provide a system and method for the detailed analysis of cost saving attained in the procurement of goods and services in the organization. While the cost saving could simply mean the amount of money saved, there are several components of the cost saving in the context of the procurement process. These different components have different implications in terms of gauging performance of the procurement departments/professionals, impact of cost saving on organization's profit and loss, impact of cost saving on organizations operational capacity/efficiency, etc. It thus becomes essential to be able to effectively track these various components of the cost saving, so that they can be properly accounted for. The present invention provides techniques for this purpose.

The techniques according to the present invention can advantageously facilitate analysis of the various components of the cost saving. For example, by practicing the present invention, it becomes possible to separate that component of cost saving which has material impact on the financial balance sheet from another component which is indicative of the performance of the procurement department. As yet another example, it becomes possible to separate that component of cost saving which is achieved at the expense of reduced consumption from another component which is indicative of effective negotiation with the supplier. As a further example, the present invention provides for commodity, inflation and currency variations to be factored into cost components.

Moreover, in an embodiment, the present invention provides the saving tracker system that is based on readily available computing technologies. The embodiment utilizing these computing technologies can also facilitate tracking of cost saving in complex, large volume and/or large diversity procurement processes. It also facilitates ready integration with other business functions such as financial accounting, forecasting, procurement performance monitoring, etc.

In a specific embodiment of the present invention, a computer based system for tracking cost saving in a procurement process is provided. The system comprises a processor unit. Moreover, the system comprises a computer readable medium storing instructions, which are executable by the processor unit. The instructions are programmed to perform the steps of receiving an input identifying a stage within a procurement process for a selected goods and/or service item, receiving an input associated with baseline cost information for the selected item, receiving an input associated with purchase price information for the selected item. Moreover, the instructions are programmed to perform the steps of identifying a plurality of components for cost saving, computing the plurality of the components for the cost saving based at least upon the baseline cost information and the purchase cost information, and transferring indication of the plurality of the components for the cost saving which are computed. The instructions are also programmed to adjust at least one of the plurality of the components for the cost saving utilizing at least one factor selected from the group of factors consisting of currency exchange rate, commodity price, and inflation rate. In alternative embodiments, associated methods for tracking cost saving in a procurement process are also provided.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, a person of ordinary skill in the art can contemplate various alternatives, variations and modifications to the illustrated embodiments within the scope of the invention disclosed herein.

FIG. 1 illustrates an exemplary computer network environment appropriate for a specific embodiment of the present invention;

FIG. 2 illustrates an exemplary computer apparatus that can provide a computing platform to practice specific embodiments of the present invention;

FIG. 3 illustrates an exemplary schematic of a system for cost saving analysis according to a specific embodiment of the present invention;

FIG. 4 illustrates an exemplary flow of steps in a method for cost saving analysis according to a specific embodiment of the present invention; and

FIG. 5A, FIG. 5B, FIG. 6A, and FIG. 6B illustrate exemplary computer screenshots illustrating certain cost saving analyses, according to embodiments of the present invention.

### DETAILED DESCRIPTION OF THE INVENTION

The present invention is generally related to the function of procurement of goods and services in organizations.

The procurement departments and/or professionals are often incentivized to reduce the procurement cost. The cost reduction of procurement is often called as cost saving.

While the cost saving could simply mean the amount of money saved, there are several components of the cost saving in the context of the procurement process. These different components have different implications in terms of gauging performance of the procurement departments/professionals, impact of cost saving on organization's profit and loss, impact of cost saving on organizations operational capacity/efficiency, etc. It thus becomes desirable to be able to effectively track these various components of the cost saving, so that they can be properly accounted for. The present invention provides techniques for this purpose.

Described below in more detail, are certain exemplary components of cost saving.

Cost reduction: This component typically reflects directly on the profit and loss of the organization. It also reflects on the performance of the procurement function.

Cost avoidance: This component typically reflects on the performance of the procurement function in terms of avoiding anticipated cost increase.

Quantity reduction vs. price reduction: This component typically attributes the reason for cost saving to change in the consumption volume and/or change in price of procurement.

Merely to facilitate understanding of such different components of cost saving, the following examples are provided. These examples are illustrative, rather than limiting.

### EXAMPLE 1

In this example, suppose that the organization needs 10 units of certain item to be procured during a certain time period, say each year. Suppose the organization purchases 10 units at $10 each during year 2010, but expects the prices to go up to $13 in the year 2011. Suppose that the procurement function negotiates with the supplier much earlier in the year 2010 and manages to get 10 units for year 2011 at a price of $9 per unit. In this case, the cost saving (cost avoidance) due to early negotiation is 10×$3=$30 and the cost reduction is 10×$1=$10.

### EXAMPLE 2

In the above scenario, suppose that the procurement team negotiates with the supplier in the year 2010 and manages to get 10 units for year 2011 at a price of $11 per unit. In this case, the cost saving (cost avoidance) due to early negotiation is 10×$2=$20 and the negative cost reduction (or increase in cost) is 10×$1=$10.

### EXAMPLE 3

In this example, suppose that the organization has set a baseline cost of one unit of item as $10, which for example can be current reasonable price in the market. Further suppose that the organization needs 10 units of this item to operate during a certain time period, say each year. In the year 2011, suppose the procurement purchases 20 items at $9 each, because the supplier agrees to give $1 discount on each item if at least 20 are purchased. Then, the cost saving due to effective negotiation is 10×x $1=$10, and negative cost saving (or increased cost) due to volume increase is 10×$9=$90.

### EXAMPLE 4

In the above example, suppose that the procurement purchases only 5 items at $9 each, because of decreased consumption need. Then, the cost saving due to effective negotiation is 10×$1=$10, and cost saving due to volume decrease is 5×$9=$45.

The components of cost saving such as cost reduction, cost avoidance, etc. are often called as benefit type of cost saving. The components of cost saving related to changes in quantity, quantity, etc. are often called as impact type of cost saving.

As can be seen, it is desirable to properly account for different components of the cost saving in a procurement process. The techniques according to the present invention advantageously facilitate tracking various components of cost saving in procurement process, for example, vis-à-vis their relevance to the organization. For example, by practicing the present invention, it becomes possible to separate that component of cost saving which has material impact on the balance sheet from another component which is indicative of the performance of the procurement department. As yet another example, it becomes possible to separate that component of cost saving which is achieved as a result of reduced consumption from another component which is indicative of effective negotiation with the supplier.

The specific embodiments of the present invention are described below in greater detail. The following description of the specific embodiments refers at various places to the accompanying drawings and specific environments, applications, platforms, examples, computer screenshots, and implementations. Such description is provided for thorough understanding of the present invention and is illustrative rather than limiting.

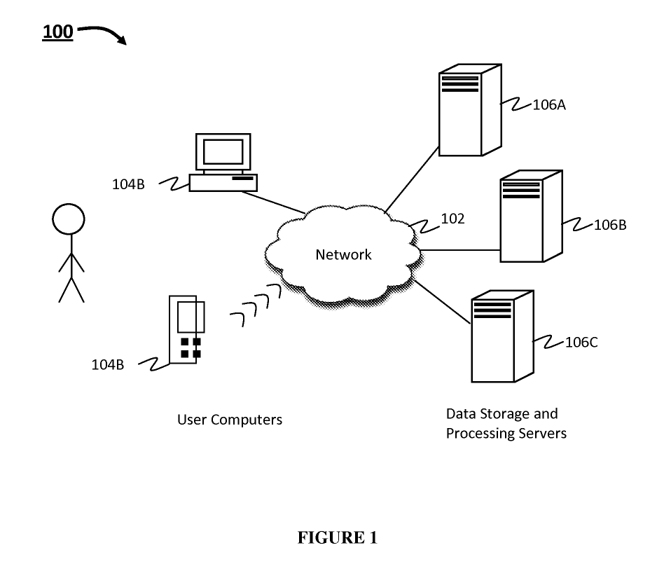

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), tablets, and smart phones. The computer systems 104, 106 etc. can exchange information using the computer network 102.

The servers 106 store digitized content which can be accessed (e.g., read, downloaded, searched, changed etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HypterText Transfer Protocol Secure), though other techniques can also be used. Access to some portions of the content may require authentication and/or authorization for access.

Depending upon embodiments of the present invention, the servers 106 and the computer systems 104 can be configured to perform certain acts. For example, the servers 106 and the computer systems 104 can include software which can facilitate performing these acts. These acts can include various acts performed by the “user interaction module,” by the “cost saving analysis module,” by the “spend management module”, and by the “financial accounting module.” The acts can also include various acts for interaction between these modules.

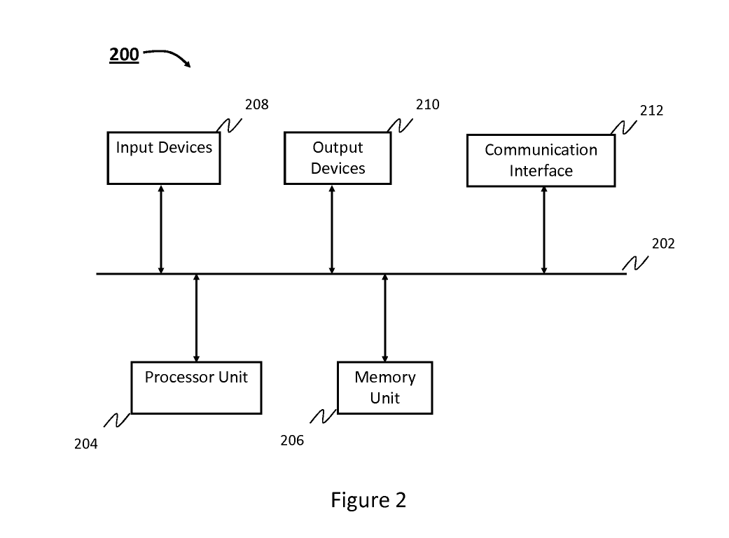

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables communication with other devices and systems via a network. For example, the communication interface can include Ethernet interface, optical network interface, wireless interface etc.

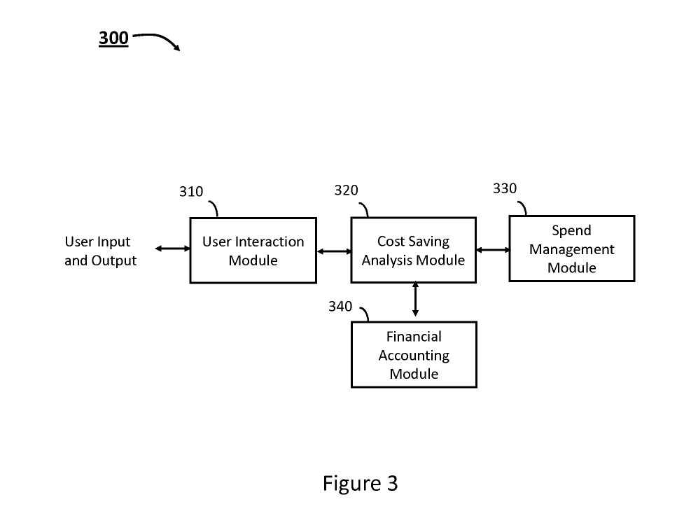

FIG. 3 illustrates an exemplary schematic 300 of a system for saving tracking according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers. The user interaction module 310 provides interface between user and machine, and performs acts such as receiving input from user and providing output to the user. The spend management module 330 typically stores procurement information, such as past procurement records. The saving analysis module 320 can perform various acts associated with analyzing the cost saving. The financial accounting module 340 can perform various acts associated with balance sheet preparation, profit and loss statement preparation, etc.

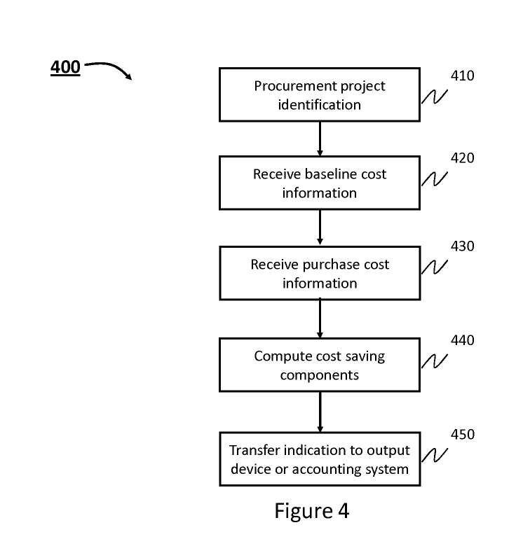

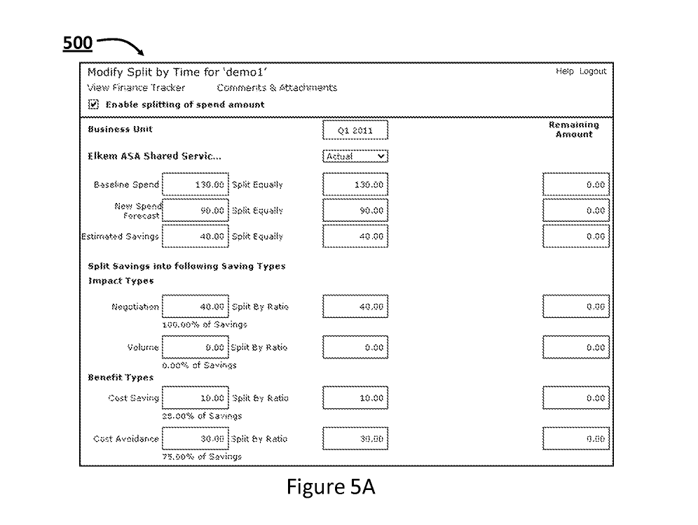

A flowchart 400 illustrating exemplary cost saving analysis process according to an embodiment of the present invention is shown in FIG. 4. For example, the process as illustrated in FIG. 4 can be performed utilizing the systems of FIGS. 1-3. At step 410, the method 400 can accept procurement project identification information such as title, description, owner, duration, start time, end time, currency, type of item(s) to be sourced, their quantity and quality, etc. According to an embodiment of the present invention which utilizes computer apparatus, the method can accept such information by way of input from the user in a computer screen (for example, as facilitated by the user interaction module 310).

Further at step 420, the method can accept baseline cost information associated with the item(s) identified in step 410. The baseline cost information serves as a reference based on which the cost saving components can be computed. The baseline cost information can be generated based upon any of the appropriate criteria such as current reasonable price in the market, average of historical prices, the commodity index, anticipated price in future, etc. According to an embodiment of the present invention which utilizes computer apparatus, the method can accept the baseline cost information by way of input from the user in a computer screen (for example, as facilitated by the user interaction module 310).

At step 430, the method can accept actual or negotiated purchase cost information associated with the item(s) identified in step 410. In an embodiment, the purchase cost information can be received from the spend management module 330 which stores procurement records. In an alternative embodiment, the purchase cost information can be provided by user via the user interaction module 310.

At step 440, the method computes one or more components of cost saving. In an embodiment, the method can accept user input specifying the one or more cost saving components to be computed. The computation can be based upon pre-configured or user supplied formulas.

Moreover, at step 450, the method can transfer information associated with the cost saving components to display device, printer device, or another computer system such as computer based financial accounting system.

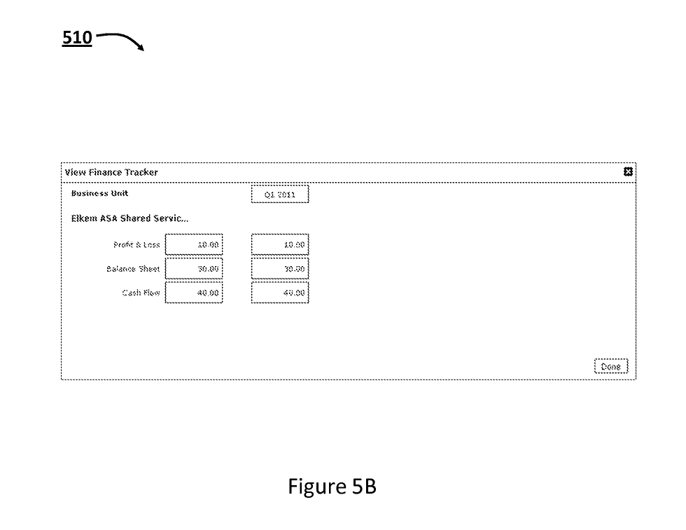

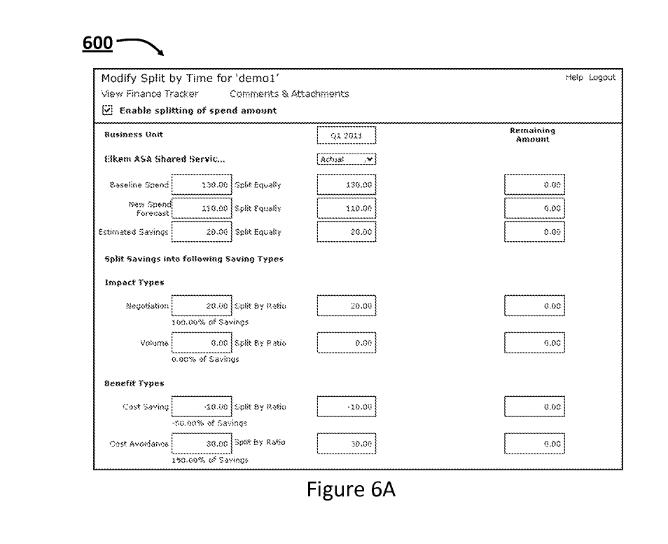

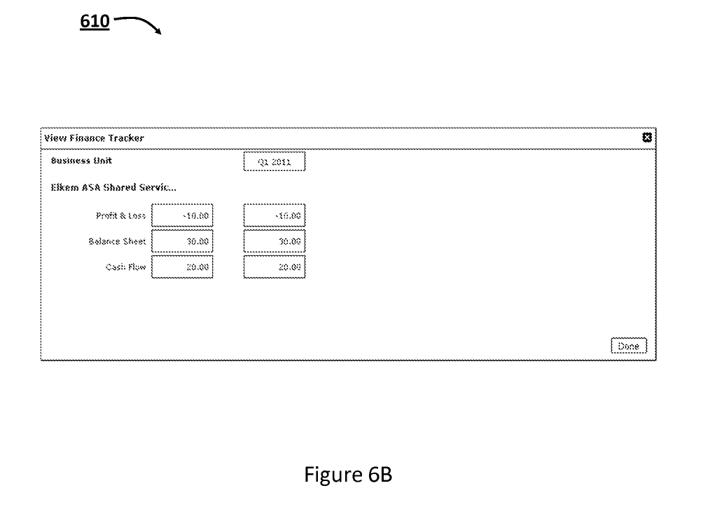

An exemplary computer screenshot 500 illustrating cost saving analysis according to an embodiment of the present invention is shown in FIG. 5A. In this screenshot, the scenario described above in Example 1 is used. Further, an exemplary computer screenshot 510 illustrating certain way of accounting for different components of the cost saving for this example is shown in FIG. 5B.

Another exemplary computer screenshot 600 illustrating cost saving analysis according to an embodiment of the present invention is shown in FIG. 6A. In this screenshot, the scenario described above in Example 2 is used. Further, an exemplary computer screenshot 610 illustrating certain way of accounting for different components of the cost saving for this example is shown in FIG. 6B.

There are often additional factors which affect the analysis of cost saving. For example, in the international procurement process, the currency exchange rate variations often affect the cost saving analysis. As other examples, the inflation rate and the commodity price variations may also affect the cost saving analysis. Merely to facilitate the understanding of such factors, the following examples are provided. These examples are illustrative, rather than limiting.

Currency exchange rate: consider a case where certain component of the cost saving for years 2010 (baseline year) and 2011 comes out to be $100 and $100, respectively. However, suppose that this particular product is procured from India and the U.S. dollar to the Indian rupee exchange rate has been 45 and 50, respectively, in those two years. Then the currency exchange rate adjusted cost saving in 2011 with respect to 2010 is in fact $100 times (50/45), which comes out to be $111.11. So, in fact the procurement has performed better in year 2011 compared to year 2010, but it is the currency exchange rate which shows year 2011 performance same as year 2010 when not adjusted for currency exchange rate variations.

Commodity prices: consider a case where certain component of the cost saving for years 2010 (baseline year) and 2011 comes out to be $100 and $100, respectively. However, suppose that the price of this particular product is dependent upon the price of specific commodity, say copper. Let us say the price of copper has been 80 and 100, respectively, in those two years. Then the commodity price adjusted cost saving in 2011 with respect to 2010 is in fact $100 times (100/80), which comes out to be $125. So, in fact the procurement has performed better in year 2011 compared to year 2010, but it is the commodity price variation which shows year 2011 performance same as year 2010 when not adjusted for commodity prices.

In certain embodiments, the cost saving component can also be adjusted to account for inflation rate.

In an embodiment, the present invention can facilitate analysis of these factors. For example, the saving analysis module 320 and/or the financial accounting module 340 of the system illustrated in schematic 300 in FIG. 3 can perform various acts associated with the analysis of these factors.

In a specific embodiment, at step 440A in a method illustrated by flowchart 400 in FIG. 4, one or more cost saving components can be adjusted for at least one or more of currency exchange rate, commodity price, and inflation rate. In a specific embodiment, the process can also facilitates user input to identify one or more factors which are to be considered for such adjustment.

Accordingly, the present invention provides a cost saving analysis system and method. While specific embodiments are described herein, alternative embodiments will be apparent to person of ordinary skill in the art, in which one or more acts described herein can be modified, performed in different order, or omitted; without departing from the spirit of the invention. Moreover, one or more acts can be added to those described herein. Such alternatives and modifications are included within the scope of the present invention.

What is claimed is:

1. A computer based system for tracking cost saving in a procurement process, the system comprising:
a processor unit; and
a computer readable medium storing instructions executable by the processor unit to perform the steps of:
receiving an input identifying a stage within a procurement process for a selected goods and/or service item;
receiving an input associated with baseline cost information for the selected item;
receiving an input associated with purchase price information for the selected item;
identifying a plurality of components for cost saving to be computed;
computing the plurality of the components for the cost saving, based at least upon the baseline cost information and the purchase cost information;
adjusting at least one of the plurality of the components for the cost saving utilizing at least one factor selected from the group consisting of currency exchange rate, commodity price, and inflation rate; and
transferring indication of the plurality of the components for the cost saving which are computed, wherein at least one of the plurality of the components has been adjusted utilizing the at least one factor.

2. The system of claim 1, wherein the plurality of the components for the cost saving include at least one benefit type component and at least one impact type component.

3. The system of claim 1, wherein the plurality of the components for the cost saving include a plurality of benefit type components.

4. The system of claim 3, wherein the plurality of the benefit type components include a cost reduction component and a cost avoidance component.

5. The system of claim 1, wherein the plurality of the components of the cost saving include a plurality of impact type components that are indicative of a plurality reasons for the cost saving, respectively.

6. The system of claim 5, wherein the plurality of the impact type components include a cost saving component due to decrease in quantity and a cost saving component due to decrease in price.

7. The system of claim 1, wherein the transferring the indication of the plurality of the components for the cost saving being transferring the indication to a display device.

8. The system claim 1, wherein the transferring the indication of the plurality of the components for the cost saving being transferring the indication to a computer based financial accounting system for incorporation in financial accounts.

9. The system of claim 1, wherein the computing any of the plurality of the components for the cost saving utilizing pre-configured formula for that component.

10. The system of claim 1, wherein the plurality of the components for the cost saving relate to a plurality of heads in the financial accounts, respectively.

11. The system of claim 1, wherein the stage within the procurement process being a stage selected from the group consisting of a forecast stage, a negotiation stage, a contract stage, and a purchase stage.

12. A computer implemented method for tracking cost saving in a procurement process, comprising:
receiving an input identifying a stage within a procurement process for a selected goods and/or service item;
receiving an input associated with baseline cost information for the selected item;
receiving an input associated with purchase price information for the selected item;
identifying a plurality of components for cost saving to be computed;
computing the plurality of the components for the cost saving, based at least upon the baseline cost information and the purchase cost information;
adjusting at least one of the plurality of the components for the cost saving utilizing at least one factor selected from the group consisting of currency exchange rate, commodity price, and inflation rate; and
transferring indication of the plurality of the components for the cost saving which are computed, and wherein at least one of the plurality of the components has been adjusted utilizing the at least one factor.

13. The method of claim 12, wherein the plurality of the components for the cost saving include at least one benefit type component and at least one impact type component.

14. The method of claim 12, wherein the plurality of the components for the cost saving include a plurality of benefit type components.

15. The method of claim 14, wherein the plurality of the benefit type components include a cost reduction component and a cost avoidance component.

16. The method of claim 12, wherein the plurality of the components of the cost saving include a plurality of impact type components that are indicative of a plurality reasons for the cost saving, respectively.

17. The method of claim 16, wherein the plurality of the impact type components include a cost saving component due to decrease in quantity and a cost saving component due to decrease in price.

18. The method of claim 12, wherein the transferring the indication of the plurality of the components for the cost saving being transferring the indication to a display device.

19. The method claim 12, wherein the transferring the indication of the plurality of the components for the cost saving being transferring the indication to a computer based financial accounting system, wherein the plurality of the components for the cost saving relate to a plurality of heads in the financial accounts, respectively.

20. The method of claim 12, wherein the stage within the procurement process being a stage selected from the group consisting of a forecast stage, a negotiation stage, a contract stage, and a purchase stage.
